(19) United States
(12) Patent Application Publication
(10) Pub. No.: US 2026/0112001 A1
(43) Pub. Date: Apr. 23, 2026

(54) METHOD FOR GENERATING AN OVERALL IMAGE OF A SAMPLE

(71) Applicant: Carl Zeiss Microscopy GmbH, Jena (DE)

(72) Inventors: Manuel Amthor, Jena (DE); Daniel Haase, Jena (DE)

(73) Assignee: Carl Zeiss Microscopy GmbH, Jena (DE)

(21) Appl. No.: 19/362,965

(22) Filed: Oct. 20, 2025

(30) Foreign Application Priority Data
Oct. 21, 2024 (DE) 10 2024 130 585.1

(51) Int. Cl. G06T 5/50; G06T 3/40; G06T 7/00

(52) U.S. Cl. CPC G06T 5/50; G06T 3/40; G06T 7/0002; G06T 2207/20081; G06T 2207/20212; G06T 2207/30168

(57) ABSTRACT

A method generates an overall image of a sample, wherein the method includes providing at least two image recordings of the sample; providing a respective coefficient array for the at least two image recordings; combining the at least two image recordings to form a combined image of the sample, wherein the contributions of the image portions of the respective image recording to the combined image are determined by the respective coefficient array; modifying at least one coefficient array of the coefficient arrays to improve the quality of the combined image; combining the at least two image recordings to form a new combined image of the sample on the basis of the modified coefficient arrays; and outputting the new combined image as overall image or forming the overall image on the basis of the modified coefficient arrays from at least two image recordings of the sample and outputting the overall image.

### CROSS-REFERENCE TO RELATED APPLICATIONS

This patent application claims priority to German Patent Application No. 10 2024 130 585.1, filed on Oct. 21, 2024 in the German Patent and Trade Mark Office, the entire disclosure of which is hereby incorporated by reference herein.

### BACKGROUND OF THE INVENTION

### Field of the Invention

The invention relates to a method for generating an overall image of a sample.

### Description of Related Art

An overall image of a sample is frequently formed from multiple individual image recordings of the sample. In this context the image recordings may include different illuminations of the sample, for example. By forming an overall image of the sample from multiple image recordings, it is for example possible to remove reflections of the illumination sources and/or artifacts.

A disadvantage here is that fine details present in the individual image recordings are destroyed in the overall image of the sample. Furthermore, new artifacts and/or hallucinations may arise in the overall image. Moreover, much time and/or great computational outlay is needed in order to generate a good overall image from the high-resolution image recordings. Additionally, implicit denoising is performed, but this is undesirable on at least some occasions.

### SUMMARY OF THE INVENTION

The problem addressed by the invention is that of providing a method for generating an overall image of a sample from multiple image recordings of the sample, which is technically straightforward and in which the generation of artifacts and/or hallucinations is reliably avoided.

The invention includes but is not limited to the following embodiments:

1. A method for generating an overall image of a sample, the method comprising:
providing at least two image recordings of the sample;
providing a respective coefficient array for the at least two image recordings;
combining the at least two image recordings to form a combined image of the sample, wherein contributions of image portions of the at least two respective image recordings to the combined image are determined by the respective coefficient array;
modifying at least one coefficient array of the respective coefficient array in order to improve the quality of the combined image;
combining the at least two image recordings to form a new combined image of the sample on the basis of the modified coefficient arrays; and
outputting the new combined image as overall image or forming the overall image on the basis of the modified coefficient arrays from at least two image recordings of the sample and outputting the overall image.

2. The method according to embodiment 1, wherein
the quality of the combined image is assessed, and the modifying of at least one coefficient array of the coefficient arrays in order to improve the quality of the combined image is performed on the basis of an assessed quality of the combined image.

3. The method according to embodiment 1, wherein
combining the at least two image recordings to form the new combined image is followed by an assessment of the quality of the new combined image and a comparison of the quality of the new combined image with a predetermined minimum value,
wherein, should the quality of the new combined image be greater than or equal to a minimum value, the method continues with outputting the new combined image as overall image or forming the overall image on the basis of the modified coefficient arrays from at least two image recordings of the sample and outputting the overall image,
wherein, should the quality of the new combined image be below the minimum value, the following are carried out:
modifying at least one coefficient array of the coefficient arrays again in order to improve the quality of the new combined image, and
combining the at least two image recordings to form a further combined image of the sample, wherein contributions of the image portions of the respective image recording to the further combined image are determined by the respective coefficient array,
wherein the further combined image is used as new combined image in outputting the new combined image as overall image.

4. A method for generating an overall image of a sample, the method comprising:
providing at least two image recordings of the sample;
providing a respective coefficient array for the at least two image recordings; and
combining the at least two image recordings to form an overall image of the sample, wherein the contributions of the image portions of the respective image recording to the overall image are determined by the respective coefficient array,
wherein the coefficient arrays are determined by a machine learning system.

5. The method according to embodiment 1, wherein
the at least two image recordings of the sample, from which the combined image and/or the new combined image and/or the further combined image are formed, have a lower resolution than the two image recordings of the sample that are used to form the overall image.

6. The method according to embodiment 1, wherein
the quality of the combined image and/or of the new combined image and/or of the further combined image is determined by comparing the combined image and/or the new combined image and/or the further combined image with a target image.

7. The method according to embodiment 6, wherein
the target image is generated by an image-to-image transformation on the basis of the image recordings of the sample.

8. The method according to embodiment 1, wherein
a gradient descent method is used in modifying the at least one coefficient array.

9. The method according to embodiment 8, wherein
a difference is determined between the target image and the combined image and/or the new combined image and/or the further combined image in the gradient descent method, and at least one coefficient array for reducing the difference between the target image and the combined image and/or the new combined image and/or the further combined image is modified on the basis of the determined difference.

10. The method according to embodiment 1, wherein
the resolution of the respective coefficient array is initially lower than the resolution of the respective associated image recording, wherein combining the at least two image recordings is preceded by an upscaling of the coefficient arrays to the resolution of the respective image.

11. The method according to embodiment 1, wherein
the coefficient arrays are stored in logarithmic form and/or modified in logarithmic form.

12. The method according to embodiment 1, further comprising:
transforming at least some of the coefficients of at least one coefficient array by a function prior to combining the at least two image recordings.

13. The method according to embodiment 1, wherein
illumination of the sample in the at least two image recordings is at least partially different from one another.

14. The method according to embodiment 1, further comprising:
prior to the combination of the at least two image recordings,
determining masks for at least some of the image recordings, wherein the masks are a preliminary estimate of the contribution of the image portions of the respective image recording to the overall image.

15. The method according to embodiment 14, wherein
the distance of the respective image portion of the at least two image recordings from one or more artifacts is determined, and
the respective mask specifies a greater contribution to the overall image for image portions at a greater distance from the respective artifact than for image portions arranged closer to the artifact.

16. The method according to embodiment 15, wherein
the artifact and/or artifacts in the respective image recording is or are detected by a thresholding algorithm and/or by a machine learning system.

17. The method according to embodiment 1, wherein
combining the at least two image recordings is preceded by the at least two image recordings being pre-processed.

18. The method according to embodiment 1, wherein
combining the at least two image recordings is preceded by increasing the number of image recordings.

19. A computer program product having instructions that are readable by a processor of a computer and that, when executed by the processor, cause the processor to carry out the method according to embodiment 1.

20. A computer-readable medium, on which the computer program product according to embodiment 19 is stored.

### BRIEF DESCRIPTION OF THE DRAWINGS

FIG. 1 shows a schematic sequence of an exemplary first embodiment of the method according to the invention for generating an overall image of a sample.

FIG. 2 shows a schematic view of combining the image recordings and a graphical illustration of the associated coefficient array.

FIG. 3 shows a schematic sequence of an exemplary second embodiment of the method according to the invention for generating an overall image of a sample.

FIG. 4 shows a schematic sequence of an exemplary third embodiment of the method according to the invention for generating an overall image of a sample.

### DETAILED DESCRIPTION OF THE INVENTION

This problem is solved by a method as described in embodiment 1.

In particular, the problem is solved by a method for generating an overall image of a sample, wherein the method comprises the following steps: providing at least two image recordings of the sample; providing a respective coefficient array for the at least two image recordings; combining the at least two image recordings to form a combined image of the sample, wherein the contributions of the image portions of the respective image recording to the combined image are determined by the respective coefficient array; modifying at least one coefficient array of the coefficient arrays in order to improve the quality of the combined image; combining the at least two image recordings to form a new combined image of the sample on the basis of the modified coefficient arrays; and outputting the new combined image as overall image or forming the overall image on the basis of the modified coefficient arrays from at least two image recording of the sample and outputting the overall image.

An advantage thereof is that the generation of the overall image cannot give rise to any artifacts not already present in the individual image recordings and cannot give rise to any hallucinations since all the information in the overall image originates from at least one of the image recordings. The overall image may thus be considered to be a (linear) combination of the image recordings of the sample. Moreover, no implicit denoising of the image recordings is performed.

This problem is solved by a method as described in embodiment 4.

In particular, the problem is solved by a method for generating an overall image of a sample, wherein the method comprises the following steps: providing at least two image recordings of the sample; providing a respective coefficient array for the at least two image recordings; and combining the at least two image recordings to form an overall image of the sample, wherein the contributions of the image portions of the respective image recording to the overall image are determined by the respective coefficient array, wherein the coefficient arrays are determined by means of a machine learning system.

An advantage thereof is that an overall image that has no (additional) artifacts not already present in the image recordings and has no hallucinations is generated quickly and technically straightforwardly. Moreover, no denoising is performed. An advantage thereof is that no hallucinations and/or additional artifacts are generated in the overall image despite the use of a machine learning system.

In particular, the problem is also solved by a computer program product having instructions that are readable by a processor of a computer and that, when executed by the processor, cause the processor to carry out the above-described method. In particular, the problem is also solved by a computer-readable medium, on which the computer program product is stored.

According to an embodiment of the method, the quality of the combined image is assessed, and the step of modifying at least one coefficient array of the coefficient arrays in order to improve the quality of the combined image is performed on the basis of the assessed quality of the combined image. An advantage thereof is that the quality of the combined image is improved technically straightforwardly.

According to an embodiment of the method, the step of combining the at least two image recordings to form the new combined image is followed by an assessment of the quality of the new combined image and a comparison of the quality of the new combined image with a predetermined minimum value, wherein, should the quality of the new combined image be greater than or equal to the minimum value, the method continues with the step of outputting the new combined image as overall image or forming the overall image on the basis of the modified coefficient arrays from at least two image recordings of the sample and outputting the overall image, wherein, should the quality of the new combined image be below the minimum value, the following steps are carried out: modifying at least one coefficient array of the coefficient arrays again in order to improve the quality of the new combined image, and combining the at least two image recordings to form a further combined image of the sample, wherein the contributions of the image portions of the respective image recording to the further combined image are determined by the respective coefficient array, and wherein the further combined image is used as new combined image in the step of outputting the new combined image as overall image. This allows the improvement in the combined image or overall image to be continued until a predetermined minimum value of quality has been reached.

According to an embodiment of the method, the at least two image recordings of the sample, from which the combined image and/or the new combined image and/or the further combined image are formed, have a lower resolution than the two image recordings of the sample that are used to form the overall image. An advantage thereof is that the coefficient arrays can be improved or optimized with particularly little outlay in terms of time or computational outlay, but the overall image can nevertheless be formed from image recordings with a higher or particularly high resolution. Hence the method is particularly efficient.

According to an embodiment of the method, the quality of the combined image and/or of the new combined image and/or of the further combined image is determined by comparing the combined image and/or the new combined image and/or the further combined image with a target image. An advantage thereof is that the quality of the combined image or of the new combined image or of the further combined image can be determined particularly reliably and simultaneously in relation to multiple properties.

According to an embodiment of the method, the target image is generated by means of an image-to-image transformation, in particular by a machine learning system, on the basis of the image recordings of the sample. An advantage thereof is that the target image can be generated technically straightforwardly and quickly. Moreover, the target image is particularly similar to an ideal image of the sample. As a result, the overall image can be optimized particularly efficiently.

According to an embodiment of the method, a gradient descent method is used in the step of modifying the at least one coefficient array. An advantage thereof is that the overall image is formed with little time outlay, or a good or optimized overall image is formed quickly.

According to an embodiment of the method, a difference is determined between the target image and the combined image and/or the new combined image and/or the further combined image in the gradient descent method, and at least one coefficient array for reducing the difference between the target image and the combined image and/or the new combined image and/or the further combined image is modified on the basis of the determined difference. This allows the difference between the combined image or the new combined image or the further combined image or the overall image and the target image to be reduced quickly in technically straightforward fashion.

According to an embodiment of the method, the resolution of the respective coefficient array is initially lower than the resolution of the respective associated image recording, wherein the step of combining the at least two image recordings is preceded by an upscaling of the coefficient arrays to the resolution of the respective image. This prevents overfitting within the scope of optimizing or improving the overall image or within the scope of modifying the coefficient arrays. In this context, it may be assumed that the coefficients of adjacent pixels in the respective image recording of the sample should be similar.

According to an embodiment of the method, the coefficient arrays are stored in logarithmic form and/or modified in logarithmic form. An advantage thereof is that in the event of a change in the respective coefficient in logarithmic form, an increase in the respective value and a reduction in the respective value leads to the same modifications in the combined image. Thus, a change in the value of the brightness to a larger brightness value and to a smaller brightness value in the event of the same changes (e.g. doubling and halving, respectively) of the respective coefficient in logarithmic form can lead to similar results in the image. This is particularly advantageous should a weight decay method be used, which prevents or at least reduces arbitrary growth of the coefficients. Coefficients of zero may be set to a value minimally larger than zero (e.g. 0.0000001), in order to always allow a logarithmic form.

According to an embodiment of the method, the method furthermore includes the following step: transforming at least some of the coefficients of at least one coefficient array by means of a function prior to the step of combining the at least two image recordings. This may ensure that the coefficients satisfy one or more predetermined boundary conditions (e.g. a predetermined unit length, non-negativity, etc.).

According to an embodiment of the method, the illumination of the sample in the at least two image recordings is at least partially different from one another. This is advantageous in that it allows the generation of a combined image or overall image in which the sample is illuminated well or uniformly but no light reflections are present.

According to an embodiment of the method, the method furthermore comprises the following step prior to the combination of the at least two image recordings: determining masks for at least some of the image recordings, wherein the masks are a preliminary estimate of the contribution of the image portions of the respective image recording to the overall image. This can significantly accelerate improving or optimizing the combined image or overall image, or a high quality of the overall image can be attained technically straightforwardly and quickly. In the event of an iterative determination of the coefficients or coefficient arrays, this can reduce the number of iterations of the method or the number of steps in the repeated modification of the coefficients.

According to an embodiment of the method, the distance of the respective image portion of the image recordings from one or more artifacts, in particular from a light reflection of the one or more light sources or from multiple light reflections of the one or more light sources used to illuminate the sample in the respective image recording, is determined, wherein the respective mask specifies a greater contribution to the overall image for image portions at a greater distance from the respective artifact, in particular the respective light reflection, than for image portions arranged closer to the artifact, in particular the respective light reflection. An advantage thereof is that the coefficients of regions comprising artifacts, e.g. strong light reflections or similar, make a particularly weak contribution to the combined image, or are not included therein at all, prior to the initial modification of the coefficients. Hence, a good combined image may be generated particularly quickly.

According to an embodiment of the method, the artifact and/or artifacts in the respective image recording is or are detected by means of a thresholding algorithm and/or by means of a machine learning system, e.g. by means of a segmentation network. As a result, artifacts may be recognized technically straightforwardly and quickly. For example, given a thresholding algorithm, an artifact, e.g. a light reflection, may be recognized or detected by a predetermined brightness value being exceeded in a portion of the image recording (which may depend on the respective surroundings in the image recording or on the brightness of the surroundings in the respective image recording). The machine learning system may be trained for the detection of artifacts by supervised learning and/or unsupervised learning.

According to an embodiment of the method, combining the image recordings is preceded by the image recordings being pre-processed; in particular, the image recordings are matched to one another in respect of their respective recorded sections of the sample, their brightness gradients, their brightness, their color and/or their noise. An advantage thereof is that the image recordings can be combined particularly efficiently with one another to form the combined image or overall image. For example, a registration may be performed (to compensate for displacements relative to one another, rotations relative to one another, scalings relative to one another, etc.) such that the image recordings are subsequently substantially the same or very similar (e.g. show the same section of the sample, whereby some image recordings may need to be trimmed under certain circumstances). A shading correction (to compensate for brightness gradients between the image recordings) is also conceivable. A further option lies in the white balance or color balance of the image recordings to one another. Denoising of one or more image recordings is also conceivable.

According to an embodiment of the method, combining the image recordings is preceded by increasing the number of image recordings, in particular by interpolating and/or extrapolating the image recordings. An advantage thereof is that a combined image or overall image with a particularly high quality can be generated.

In particular, the image recordings may be optical recordings of the sample. The sample may be an object, e.g. a slide for a laboratory.

The image recordings may be generated by an optical device (e.g. a camera or a microscope or a telescope) and may subsequently be made available.

The coefficient array may be a two-dimensional array of coefficients in particular. This means that the coefficient array is a two-dimensional table of (preferably positive) numbers or numerical values. Each coefficient of a coefficient array may specify the extent to which image portions of an image recording contribute, or the contribution of said image portions, to the combined image or overall image. Certain regions/areas or pixels of an image recording may therefore contribute to the combined image or overall image to different extents. The combined sum of the coefficients of all image recordings for the respective image portion or for the respective pixel is typically 1 or 100% since all elements or pixels in the combined image originate from at least one of the multiple image recordings. Each image recording that is combined with one or more other image recordings to form the combined image or overall image may have a dedicated coefficient array, which is assigned to the respective image recording. For example, each entry in the coefficient array may have a value of between 0% and 100%, said value specifying the percentage by which the respective pixel or the respective image portion contributes to the combined image or overall image. Should there be two image recordings that are combined to form a combined image, then the pixel top left in the first image recording may have a coefficient of e.g. 0.7 and the pixel top left in the second image recording may have a coefficient of e.g. 0.3. Hence the specified pixel from the first image recording contributes 70% to the combined image, and the specified pixel from the second image recording contributes 30%. The combined sum of the coefficients for the same pixel from all utilized image recordings is 1 or 100% as a rule.

The phrase “contribute to the combined image” or “contributions to the combined image” may in particular be understood to mean the extent to which the respective pixel in the respective image recording or the respective image portion in the respective image recording is carried over into the combined image or overall image. For example, 30% of the brightness of the respective pixel or the respective image portion may be carried over from a first image recording, 50% from a second image recording and 20% from a third image recording. The corresponding pixel or the corresponding image portion of the combined image or overall image thus has a brightness value, 30% of which corresponds to the brightness of the pixel or the image portion in the first image recording, 50% of which corresponds to the brightness of the pixel or the image portion in the second image recording and 20% of which corresponds to the brightness of the pixel or the image portion in the third image recording. As it were, it is possible to form a linear combination of the image recordings, which then is the combined image or the overall image. It is also conceivable that the color of the respective pixel or of the respective image portion in the overall image is a combination or mixture of the colors of the respective pixels in the image recordings that are combined. Moreover, other properties of the respective pixel or of the respective image portion (e.g. saturation) that are carried over into the combined image or the overall image by combining the image recordings are also conceivable.

An image portion may in particular be understood to mean an area or a part of an image recording, in particular a single pixel or multiple pixels.

The image recordings may comprise or be color images, black and white images and/or grayscale images.

The underlying concept of the present invention is that of generating each portion or each pixel of a combined image or an overall image from the combination of image recordings of the sample such that every structure present in the combined image or in the overall image or each detail present must be present in at least one image recording to allow it to be included or be incorporated in the combined image or overall image. This reliably prevents hallucinations in the combined image or overall image, i.e. the display of structures or details not actually present in the sample. Moreover, particularly high reliability of the overall image is attained thereby, i.e. even fine or detailed structures and/or details of the sample are visible in the combined image or overall image.

Preferred embodiments will emerge from the embodiments. The invention is explained in more detail below on the basis of a drawing of an exemplary embodiment.

The same reference signs are used in the following description for parts that are the same and parts that act in the same way.

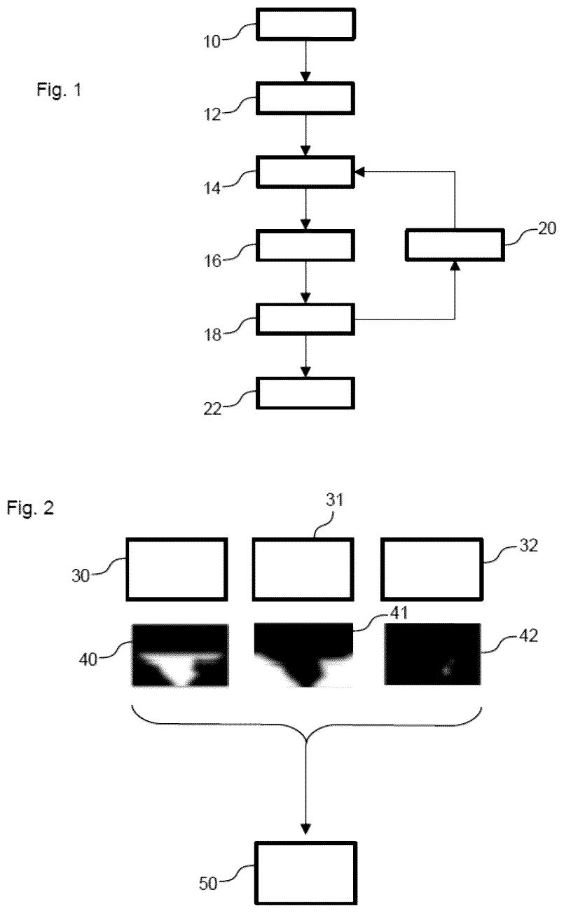

FIG. 1 shows a schematic sequence of an exemplary first embodiment of the method according to the invention for generating an overall image 50 of a sample.

Initially, at least two image recordings 30-32 of the sample are provided (step 10). For example, the image recordings 30-32 may have been generated using a camera, a cellular telephone, a microscope, a telescope or the like. The number of image recordings 30-32 may be two, three, four, five, six or more than six.

The image recordings 30-32 may be in the same domain, i.e. have a comparable image impression. The image recordings 30-32 may have different illuminations from one another. For example, various light sources are switched on or switched off or modified in terms of their intensity for the purposes of generating the multiple image recordings 30-32. It is also conceivable that the image recordings 30-32 have different focus positions or focus settings in addition to that or in an alternative. It is also possible that the recording parameters (illumination, brightness, focus, etc.) are the same or identical for the various image recordings 30-32 but that the latter were recorded at different times (in order to form a time series), for example. It is also conceivable that the image recordings 30-32 are part of a lucky imaging method, wherein optical disturbances randomly in one or more image recordings 30-32 are minimized or avoided by way of short exposure times. The aforementioned possible differences between image recordings 30-32 may also be combined with one another.

The image recordings 30-32, which may also be referred to as raw images, are combined with each other, and a combined image or an overall image 50 is generated from the image recordings 30-32. It is also conceivable that more than one combined image or overall image 50 is generated, e.g. two, three or more than three combined images or overall images.

The contribution or the proportion which the respective pixel and/or the respective image portion of the respective image recording 30-32 contributes to the combined image or overall image 50 is determined by a coefficient in each case. The coefficients for each image recording 30-32 are determined in a coefficient array 40-42. Each image recording 30-32 incorporated into the combined image or overall image 50 comprises an associated or assigned coefficient array 40-42. It is naturally conceivable that two image recordings 30-32 have the same coefficient array 40-42. For a two-dimensional image, the coefficient array 40-42 has a two-dimensional table of coefficients. For image recordings 30-32 that have more than 2 (e.g. 3) dimensions, it is conceivable that the corresponding coefficient arrays 40-42 have the corresponding dimension (e.g. 3). More than three dimensions are also conceivable, wherein for example the fourth dimension is a time component.

The coefficient arrays are provided in a further step (step 12).

Each coefficient specifies the extent to which or how much the respective pixel of the image recording 30-32 or the respective area or the respective partial image of the image recording 30-32 contributes to the combined image or overall image 50. The value of the respective coefficient may typically lie between 0.00 and 1.00. The sum of the coefficients of the respective pixel or of the respective partial image in the coefficient arrays 40-42 is typically 1.00 or 100%.

FIG. 2 shows a schematic view of combining the image recordings 30-32 and a graphical illustration of the associated coefficient array 40-42.

In the graphical illustration, brighter image portions of the respective image recording 30-32 are carried over into the combined image or overall image 50 (to a greater extent), while darker image portions are carried over into the combined image or overall image 50 to a lesser extent or not at all. The darker a location of the coefficient array 40-42 is, the closer the respective coefficient is to zero. The brighter a location of the coefficient array 40-42 is, the larger the respective coefficient or the closer the value of the respective coefficient is to 1.

The combined image or overall image 50 is combined or generated from at least two image recordings 30-32 on the basis of the coefficient arrays 40-42 (step 14).

Hence, only a small image portion consisting of two relatively small oval regions is carried over into the combined image or overall image 50 from the right image recording 32 in FIG. 2. Predominantly the left lower image portion and the right lower image portion from the central image recording 31 in FIG. 2 are carried over into the combined image or overall image 50. Essentially image portions in the central region of the lower half are carried over from the left image recording 30 in FIG. 2.

The image portions carried over into the combined image or overall image 50 need not be adjacent to one another in the respective image recording 30-32. However, they may be connected.

The coefficient arrays 40-42 or coefficients may be determined by means of a machine learning system. The machine learning system is trained to generate the best possible or most optimal overall image 50 from the image recordings 30-32 by virtue of determining coefficient arrays 40-42 that are as optimal as possible.

It is also conceivable that a target image that is generated for determining the quality of the combined image is determined by means of the machine learning system.

The coefficient arrays 40-42 may be determined by an iterative optimization method.

The aim of this iterative optimization may be to determine the coefficient arrays C₁, C₂, C₃, . . . , Cₙ in such a way that a quality function or quality assessment function which assesses the quality of the combined image or overall image 50 has a particularly high value. To put it another way: The aim of this iterative optimization may lie in determining the coefficient arrays 40-42 in such a way that an error function L (I_{reconstructed}) is minimized, where I_{reconstructed} is the combined image or overall image 50. The greater the value of the error function, the greater the deviation from the desired image or an ideal image. The combined image or overall image 50 is determined by a linear combination of the image recordings 30-32 (step 14), wherein the coefficient arrays 40-42 specify the respective contribution:

$${I}_{reconstructed} = {\sum }_{n = 1 … n} {C}_{n} * {S}_{n}$$

where Sₙ is the n-th image recording and
where Cₙ is the coefficient array associated with or assigned to the n-th image recording. For example, a gradient descent method may be used in the iterative optimization. In this case, there is a movement along a direction of descent from a starting point until a numerical improvement in the combined image or overall image 50 or in the quality of the combined image or overall image 50 is no longer possible.

In this case, a difference between the respective combined image and a target image may be determined by a comparison with the target image. A loss function may be used for determining the difference or for assessing the difference. The loss function may specify the extent to which or how much the combined image differs from the target image. The error in the loss function or the difference between the actual state (combined image) and the setpoint (target image) may be “passed through” to the coefficients of the coefficient array 40-42 by back propagation. This can mean that the coefficients of the coefficient array 40-42 are changed or modified on the basis of the difference between the combined image and the target image in order to reduce or minimize the error or the difference between the combined image and the target image.

Since the operations or the applied mathematical functions used in the combination are differentiable, it is possible to use methods such as e.g. Autograd. This allows a very efficient optimization.

The respective coefficient array 40-42 may have the same resolution as the respective image recording 30-32. By preference, the respective coefficient array 40-42 initially has a lower resolution than the associated image recording 30-32. In this context, it may be assumed that the coefficients of mutually adjacent pixels should have a similar coefficient. This prevents overfitting when optimizing the combined image or the overall image 50. The resolution of the respective coefficient array 40-42 may be upsampled or upscaled to the resolution of the respective image recording 30-32 before the combined image or the overall image 50 is determined or calculated. An interpolation or smoothing may be performed in the process.

The respective coefficient array 40-42 or the values of the coefficient arrays 40-42 may be stored or modified/optimized in logarithmic form. This ensures that 0.00 is the neutral value. This is particularly advantageous if a weight decay method is used.

The coefficients of the coefficient array 40-42 may be transformed by a function before they are used for combining the combined image or the overall image 50 from the image recordings 30-32. Examples thereof are sigmoid, tan H, ReLU, softmax, etc. As a result, it is possible to model further boundary conditions for the coefficients, e.g. a unit length or the non-negativity of the respective coefficient.

A combined image or overall image 50 is formed from the image recordings 30-32 (or at least from some of the available image recordings 30-32) by linear combination by means of (initial) coefficient arrays 40-42. The quality of the combined image or of the new combined image or of the further combined image may be assessed. A comparison with a target image may be performed to this end. In this case, the coefficients may be included directly in the error function or loss function. This is particularly expedient for a regularization (ridge regression or weight decay). In an alternative to the target image or in addition, the following criteria of the combined image (individually or in combination with one another) may be included in the assessment of the quality of the combined image:
image sharpness,
brightness and/or contrast,
saturation of the intensity values (e.g. to identify clipping in the combined image),
homogeneity in the combined image,
frequency properties (e.g. by means of high-pass filtering, low-pass filtering and/or bandpass filtering, top-hat transform, etc.),
total variation,
lack of artifacts.

The determined quality of the combined image (step 16) may be compared with a predetermined minimum value of the quality (step 18). Should the quality of the combined image be greater than or equal to the predetermined minimum value, the combined image is for example output as overall image 50, and the method may be terminated (step 22). The combined image output as overall image 50 is then the optimized or best combined image on the basis of the image recordings 30-32.

Should the quality of the combined image be less than the predetermined minimum value of the quality, the coefficient array 40-42 or at least one coefficient array 40-42 is modified (step 20). It is also conceivable that the quality is not determined, or the coefficient array 40-42 or at least one coefficient array 40-42 is modified at least once, independently of the quality value or a comparison with a minimum value. For example, in a proposed method, the coefficient array 40-42 or at least one coefficient array 40-42 may be adapted or improved or modified a predetermined number of times in order to improve the quality of the combined image or of the overall image 50.

For example, the gradient descent method may be used to modify the respective coefficient array 40-42. In this case, a loss function is applied. The loss function or the respective value thereof may specify the difference between a setpoint (e.g. a predetermined target image) and an actual state (combined image). The coefficient arrays 40-42 may be modified on the basis of the value of the loss function such that the value and loss function are reduced. Hence the difference between setpoint and actual state becomes smaller.

This may mean that at least two coefficients are modified. In this case the sum of all coefficients for the respective pixel post modification is usually 100% again. Subsequently, a new combined image is generated from the (unchanged) image recordings 30-32 using the modified coefficient arrays 40-42. The quality of the new combined image may now be assessed and compared with the predetermined minimum value for the quality. If the quality now is higher than the predetermined minimum value, the new combined image is output as overall image 50. The coefficient arrays 40-42 and/or the quality value may be output together with the combined image.

Should the quality of the new combined image still not be higher than the predetermined minimum value, it is possible to modify the coefficient arrays 40-42 or a part thereof again or in renewed fashion, to generate a further combined image by means of the modified coefficient arrays 40-42 and to assess the quality of this further combined image. Depending on whether the quality of the further combined image is greater than or equal to the predetermined minimum value, the further combined image is output as overall image 50 (should the quality be greater than or equal to the minimum value) or (should the quality be lower than the minimum value) the coefficient arrays 40-42 are modified again and the above-described steps are repeated thereafter, in particular the steps of modifying the coefficient arrays 40-42, combining the image recordings 30-32 to form a combined image, comparing the combined image with the minimum value, deciding whether the quality is sufficient or whether coefficient arrays 40-42 should be modified again, etc. After a predetermined maximum number of iterations, the iterative method may be terminated by way of an error message and/or by outputting the combined image as overall image 50 (even if the minimum value of quality was not attained).

It is also possible that the quality of the combined image or of the new combined image or of the further combined image is not determined. It is also conceivable that the iterative method stops after a predetermined number of steps and the obtained combined image is output as overall image 50, or the obtained coefficient arrays 40-42 are used to combine the overall image 50 from at least two images, and said overall image is then output.

It is conceivable that the coefficient arrays 40-42 are optimized on the basis of low or lower resolution image recordings 30-32 (whose resolution was for example downsampled), and the optimized coefficient arrays 40-42 are only applied to image recordings 30-32 with a higher or full or maximum resolution after the optimization or improvement in the coefficient arrays 40-42 in order to form or combine an overall image 50 from the image recordings 30-32 by means of the coefficient arrays 40-42. The coefficient arrays 40-42 may be upscaled in the process. This allows time and computational outlay to be saved during the optimization of the coefficient arrays 40-42 since only low-resolution image recordings 30-32 are used in the process. The overall image 50 may have the same maximum resolution as the image recordings 30-32.

The image recordings 30-32 can differ not only with respect to the image brightness but can differ from one another in any type of recording parameter. Semantics are usually not determined in the present method. The coefficients are determined dynamically during the run time on the basis of the minimization of the error function.

The method may be used for artifact removal, for contrast enhancement, for HDR calculation, for shading correction, for generating an extended depth of focus (EDoF), for lucky imaging, for a “smart” axis projection (compared with the usual maximum intensity projection “MIP”, for example), for removing interfering objects in time series and/or for 2D projection.

The removal of reflections from one or more LEDs used for illuminating the sample is also possible, especially in the case of a microscope.

The image recordings 30-32 may be pre-processed before the image recordings 30-32 are combined by means of the coefficient arrays 40-42. A registration (used to compensate for shifts, rotations and scalings of the image recordings 30-32 with respect to one another) may be performed within the scope of this preprocessing. In an alternative to that or in addition, a white balance or color balance between the image recordings 30-32 may be performed. Denoising is also conceivable.

The number of image recordings 30-32 may be increased within the scope of the preprocessing. To this end, e.g. ten image recordings 30-32 may be generated from three image recordings 30-32 (e.g. by interpolation), each (in particular) having gradually changing illumination brightnesses.

Optionally, pre-masking may be performed, or masks may be used prior to the combination of the image recordings 30-32 to form the combined image. The masks are not modified during the course of the optimization method but remain the same. The masks may introduce context knowledge into the optimization method. Each image recording 30-32 may be assigned exactly one mask.

As it were, the masks represent an initial basis, on the basis of which the optimization of the coefficient arrays 40-42 may be performed.

Should masks be used, the combined image I_{reconstructed} may be defined as follows:

$${I}_{reconstructed} = {\sum }_{n = 1 … n} {C}_{n} * {M}_{n} * {S}_{n}$$

where Mₙ is the mask for the n-th image recording,
where Sₙ is the n-th image recording and
where Cₙ is the coefficient array associated with or assigned to the n-th image recording.

For the respective portion of the combined image, the masks M₁, M₂, M₃, . . . , Mₙ therefore specify the image recording 30-32 from which the image information is or should be taken.

The use of masks or pre-masking is particularly expedient should it be known that certain image portions or image regions in the image recordings 30-32 are not at all or very well suited to inclusion in the combined image or the contribution thereto.

The masks are estimated once prior to the (first) combination of the image recordings 30-32 to form the combined image and usually remain unchanged during the optimization or change of the coefficient arrays 40-42. In this case, each mask may comprise a floating-point array with weights between 0.00 and 1.00, wherein the weight for a specific pixel over all image recordings 30-32 is typically 1.00 or 100%.

For example, should the various image recordings 30-32 have been illuminated with different types of illumination or different light sources, it is possible to initially create detection masks for the respective image recordings 30-32, wherein the detection masks each indicate where reflections of the light sources are present or particularly pronounced in the image recording 30-32. This can be performed using a conventional thresholding algorithm and/or a machine learning system (e.g. by means of a segmentation network). Subsequently, it is possible to perform a distance transformation of the detection masks in order to generate the masks or pre-masking therefrom. Hence, only the image portions of the respective image recording 30-32 that are as far away as possible from, or have a minimum distance from, the reflections of the light sources are (initially) included in the combined image (argmax projection).

In this case, it is possible that each pixel in the combined image originates from an image recording 30-32 in which this pixel has the maximum distance (among the image recordings 30-32) from the respective reflection of the light sources.

A target image may be used for determining the quality of the combined image. In this case, the difference between the combined image and the target image is determined as quality value. The smaller the difference, the higher the quality of the combined image and the lower the value of a loss function.

The target image may be determined by means of an image-to-image transformation and/or by means of a machine learning system. If no artifact-free image recordings 30-32 are available for training the machine learning system, then the artifact-free region (e.g. the upper half of the image recording 30-32) may be used as target image. The model or the machine learning system in that case also generalizes to the lower image half since for example the ring LED image recordings of the sample have a symmetry and, by way of random reflections in the training, the model may be trained to remove ring LED artifacts in both image halves.

The model architecture may comprise a U-Net architecture (encoder-decoder network) and/or transformer-based architectures. It may use a residual skip in order to learn not the transformation but only the residual function by the model or in order to be trained thereon. Since the absolute image brightness of the image recordings 30-32 may be relevant in this context and should be maintained during the transformation, there may be a path in the model traversed without a normalization layer.

The model of the image-to-image transformation or of the machine learning system may be optimized with any desired loss function (e.g. L1, L2, SSIM, etc.). This may be performed by a standard training and/or in a GAN setup.

Since a quantitative prediction should be possible, input images (e.g. the image recordings 30-32) and output images (e.g. the target image) of the model should correspond to each other in terms of their brightness. In order to achieve this, e.g. the median of the background brightnesses of all image recordings 30-32 may be modified or adjusted to be the same value. A common value may be determined by averaging, min, max or the like.

In the specific application of LED artifact correction, it is possible to generate a prior model or a target image, or train a machine learning system, even without artifact-free target data. The idea in this case is that the lateral LED image recording (in which therefore only the laterally arranged LEDs are switched on) does not have any artifacts in the upper image half, and moreover the ring LED image recordings (in which therefore only the LEDs arranged in a ring shape are switched on) contain symmetric information (i.e. it is unlikely that structures never before seen in the upper image half occur in the lower image half). Thus, there can be a mapping from the two ring LED image recordings (which as input data are incorporated into the model as an image stack) onto the lateral LED image recording. In this context, learning may take place only in the upper image half. This may be performed either by entering the overall image 50 or by forming the gradient only in the upper image half. Alternatively, this may take place by cutting out random image patches for the training (corresponding in input and output images), but only from the upper image region. This may be performed in automated fashion without manual annotation, assessment or the like.

To prevent the model or the machine learning system from learning unwanted structure-image position relationships (e.g. that petri dish edges as samples always extend along the upper image edge), there may be augmentations during the training: e.g. random flips, random image cutouts, random affine transformations, etc.

The verification of the prediction and possible retraining may be performed during the ongoing operation of the camera or of the microscope. Since (in the specific application of LED artifact correction) the lateral LED image recording is not required after the training (during the inference in the ongoing operation), but actually the target image is defined for training the prior network, there can be a check (by the user) during the ongoing operation as to whether or not a current prediction of the model meets a minimum quality. To this end, there is a straightforward consideration of the difference/similarity between the upper image half of the lateral LED image and the prediction Iₚᵣᵢₒᵣ. In the case of an insufficient prediction quality, the set of image recordings 30-32 (ring and lateral LED image recordings) may be used for retraining/fine-tuning of the model (directly at the user or in collected fashion at a later time).

In order to further improve the imaging result Iₚᵣᵢₒᵣ, repeated inference with any desired image transformation (transformation and back transformation) and subsequent averaging of the results may optionally be performed. This allows random reconstruction artifacts to be removed. In detail, the following procedure may be implemented:
1. The following steps may be carried out for a predetermined number of iterations or a predetermined number of times:
a. applying an image transformation (e.g. scaling, displacement, rotation, flip, . . . ) to the input image
b. inferring the model with the transformed input image
c. back-transforming the predicted image using the inverse transformation to a.
2. Averaging the individual results to form an overall imaging result Iₚᵣᵢₒᵣ.

In this context, a trade-off should be found or sought between the number of iterations and an acceptable runtime. In principle, the desire is to average as many images as possible but there are restrictions due to the combination time or calculation time.

If there is a domain shift for the target image Iₚᵣᵢₒᵣ, it is also possible to use special loss functions instead of the usual loss functions (L1/L2). In the specific application of LED artifact correction, only a room light image recording is for example available as artifact-free target image recording. Absolute image brightnesses between initial image and target image do not necessarily correspond. It may be the case that certain regions appear brighter on account of the different types of illumination. Different reflections may also arise. Thus, the brightness profile of slide edges may be interchanged depending on the illumination direction. However, structures/textures such as image edges themselves are typically retained. In that case, e.g. a high-pass loss/top-hat loss/CLAHE loss may be used as error functions, which are focused on high-frequency components (structures in the image).

It is also conceivable that the coefficients of the coefficient arrays 40-42 may each adopt only a value of 0 or 1, where 0 means that the respective pixel or the respective region is not carried over into the combined image or overall image 50, while 1 means that the respective pixel or the respective region is carried over into the combined image or overall image 50.

The coefficient arrays 40-42 at the beginning of the method, i.e. the initial coefficient arrays, may be random or filled with random numbers and/or with predetermined or random patterns.

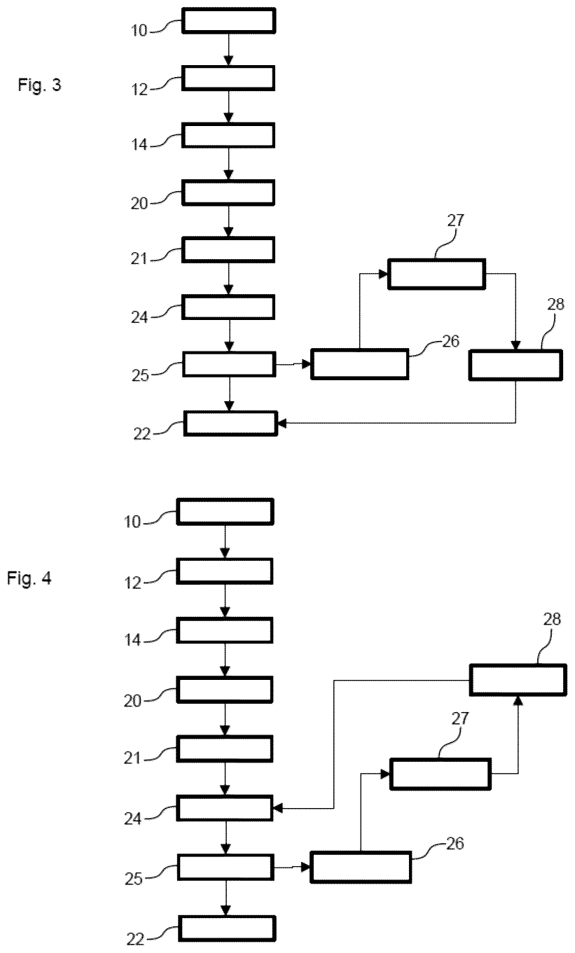

FIG. 3 shows a schematic sequence of an exemplary second embodiment of the method according to the invention for generating an overall image of a sample.

In the method, the at least two image recordings 30-32 of the sample are initially provided (step 10). Then the respective coefficient arrays 40-42 of the image recordings 30-32 (typically one coefficient array 40-42 per image recording 30-32) are made available (step 12). Now, the at least two image recordings 30-32 are combined to form a combined image of the sample (step 14). Thereupon, at least one coefficient array 40-42 is modified in order to improve the quality of the combined image (step 20). Now, the at least two image recordings 30-32 are combined to form a new combined image of the sample on the basis of the modified coefficient arrays 40-42 (step 21). The quality of the new combined image is determined (step 24), and the determined quality of the new combined image is compared with a predetermined minimum value (step 25). Two different paths are taken depending on whether the predetermined minimum value is obtained. Should the quality be greater than or equal to the predetermined minimum value, the new combined image is output as overall image 50, and/or the overall image 50 is formed on the basis of the modified coefficient arrays 40-42 from at least two image recordings 30-32 of the sample and output (step 22). Should the quality be less than the predetermined minimum value, at least one coefficient array 40-42 is modified again (step 26), and the at least two image recordings 30-32 are combined on the basis of the modified coefficient arrays 40-42 to form a further combined image of the sample (step 27). Subsequently, the further combined image is used as a new combined image (step 28). This new combined image (which is the further combined image) may now be output as overall image 50, or an overall image 50 may be generated on the basis of the once again modified coefficient arrays 40-42 from two image recordings 30-32 of the sample, and this overall image 50 may be output.

FIG. 4 shows a schematic sequence of an exemplary third embodiment of the method according to the invention for generating an overall image 50 of a sample.

It is also conceivable that the step of using the further combined image as a new combined image (step 28) is followed by the renewed determination of the quality of the new combined image (which is the further combined image) (step 24) and a comparison of the latter with a minimum value (step 25). Subsequently, should the quality be greater than or equal to the minimum value, the new combined image may be output as overall image 50, or an overall image 50 may be generated on the basis of the modified coefficient arrays 40-42 and output, as shown in FIG. 4. Should the quality (still) be lower than the minimum value, at least one coefficient array 40-42 of the coefficient arrays may be modified yet again for the purpose of improving the quality of the combined image or overall image 50 (step 26) and then a combined image may be generated again (step 27), and this combined image may again be used as a new combined image (step 28), this being followed by the quality of the new combined image being determined again (step 24), etc.

In this way, the method or parts of the method may be repeated until the minimum value of the quality was reached by the combined image. It is also conceivable that a certain number of repetitions of the aforementioned steps is performed, and the step of outputting the new combined image as overall image 50 or of forming and outputting the overall image 50 on the basis of the modified coefficient arrays 40-42 from at least two image recordings 30-32 of the sample is carried out even if the minimum value of quality is not achieved. In addition, an error message may be output and/or the attained quality value may be output in this case.

### LIST OF REFERENCE SIGNS

10 Step of providing at least two image recordings of the sample
12 Step of providing a coefficient array in each case
14 Step of combining the at least two image recordings to form a combined image of the sample
16 Step of determining the quality of the combined image
18 Step of comparing the quality of the combined image with a predetermined minimum value
20 Step of modifying at least one coefficient array
21 Step of combining the at least two image recordings to form a new combined image of the sample on the basis of the modified coefficient arrays
22 Step of outputting the new combined image as overall image or of forming and outputting the overall image on the basis of the modified coefficient arrays from at least two image recordings of the sample
24 Step of determining the quality of the new combined image
25 Step of comparing the quality of the new combined image with a predetermined minimum value
26 Step of modifying at least one coefficient array again
27 Step of combining the at least two image recordings to form a further combined image of the sample on the basis of the modified coefficient arrays
28 Step of using the further combined image as new combined image
30-32 Image recordings
40-42 Coefficient array
50 Overall image

1. A method for generating an overall image of a sample, the method comprising:
providing at least two image recordings of the sample;
providing a respective coefficient array for the at least two image recordings;
combining the at least two image recordings to form a combined image of the sample, wherein contributions of image portions of the at least two respective image recordings to the combined image are determined by the respective coefficient array;
modifying at least one coefficient array of the respective coefficient array in order to improve the quality of the combined image;
combining the at least two image recordings to form a new combined image of the sample on the basis of the modified coefficient arrays; and
outputting the new combined image as overall image or forming the overall image on the basis of the modified coefficient arrays from at least two image recordings of the sample and outputting the overall image.

2. The method according to claim 1, wherein
the quality of the combined image is assessed, and the modifying of at least one coefficient array of the coefficient arrays in order to improve the quality of the combined image is performed on the basis of an assessed quality of the combined image.

3. The method according to claim 1, wherein
combining the at least two image recordings to form the new combined image is followed by an assessment of the quality of the new combined image and a comparison of the quality of the new combined image with a predetermined minimum value,
wherein, should the quality of the new combined image be greater than or equal to a minimum value, the method continues with outputting the new combined image as overall image or forming the overall image on the basis of the modified coefficient arrays from at least two image recordings of the sample and outputting the overall image,
wherein, should the quality of the new combined image be below the minimum value, the following is carried out:
modifying at least one coefficient array of the coefficient arrays again in order to improve the quality of the new combined image, and
combining the at least two image recordings to form a further combined image of the sample, wherein contributions of the image portions of the respective image recording to the further combined image are determined by the respective coefficient array,
wherein the further combined image is used as new combined image in outputting the new combined image as overall image.

4. A method for generating an overall image of a sample, the method comprising:
providing at least two image recordings of the sample;
providing a respective coefficient array for the at least two image recordings; and
combining the at least two image recordings to form an overall image of the sample, wherein the contributions of the image portions of the respective image recording to the overall image are determined by the respective coefficient array,
wherein the coefficient arrays are determined by a machine learning system.

5. The method according to claim 1, wherein
the at least two image recordings of the sample, from which the combined image and/or the new combined image and/or the further combined image are formed, have a lower resolution than the two image recordings of the sample that are used to form the overall image.

6. The method according to claim 1, wherein
the quality of the combined image and/or of the new combined image and/or of the further combined image is determined by comparing the combined image and/or the new combined image and/or the further combined image with a target image.

7. The method according to claim 6, wherein
the target image is generated by an image-to-image transformation on the basis of the image recordings of the sample.

8. The method according to claim 1, wherein
a gradient descent method is used in modifying the at least one coefficient array.

9. The method according to claim 8, wherein
a difference is determined between the target image and the combined image and/or the new combined image and/or the further combined image in the gradient descent method, and at least one coefficient array for reducing the difference between the target image and the combined image and/or the new combined image and/or the further combined image is modified on the basis of the determined difference.

10. The method according to claim 1, wherein
the resolution of the respective coefficient array is initially lower than the resolution of the respective associated image recording, wherein combining the at least two image recordings is preceded by an upscaling of the coefficient arrays to the resolution of the respective image.

11. The method according to claim 1, wherein
the coefficient arrays are stored in logarithmic form and/or modified in logarithmic form.

12. The method according to claim 1, further comprising:
transforming at least some of the coefficients of at least one coefficient array by a function prior to combining the at least two image recordings.

13. The method according to claim 1, wherein
illumination of the sample in the at least two image recordings is at least partially different from one another.

14. The method according to claim 1, further comprising:
prior to the combination of the at least two image recordings,
determining masks for at least some of the image recordings, wherein the masks are a preliminary estimate of the contribution of the image portions of the respective image recording to the overall image.

15. The method according to claim 14, wherein
the distance of the respective image portion of the at least two image recordings from one or more artifacts is determined, and
the respective mask specifies a greater contribution to the overall image for image portions at a greater distance from the respective artifact than for image portions arranged closer to the artifact.

16. The method according to claim 15, wherein
the artifact and/or artifacts in the respective image recording is or are detected by a thresholding algorithm and/or by a machine learning system.

17. The method according to claim 1, wherein
combining the at least two image recordings is preceded by the at least two image recordings being pre-processed.

18. The method according to claim 1, wherein
combining the at least two image recordings is preceded by increasing the number of image recordings.

19. A computer program product having instructions that are readable by a processor of a computer and that, when executed by the processor, cause the processor to carry out the method according to claim 1.

20. A computer-readable medium, on which the computer program product according to claim 19 is stored.
